(19) United States
(12) Patent Application Publication
(10) Pub. No.: US 2026/0328321 A1
(43) Pub. Date: Oct. 22, 2026

(54) ADJUSTABLE LENGTH PIPE NIPPLE DEVICE

(71) Applicant: Joel Jolin, Leona, TX (US)

(72) Inventor: Joel Jolin, Leona, TX (US)

(21) Appl. No.: 19/181,472

(22) Filed: Apr. 17, 2025

(51) Int. Cl. F16L 27/12

(52) U.S. Cl. CPC F16L 27/127

(57) ABSTRACT

An adjustable length pipe nipple device includes a first pipe section having an open first end and an open second end. First pipe threading is positioned adjacent the first end for coupling to a first component. A second pipe section has an open primary end and an open secondary end. Second pipe threading is positioned at the secondary end for coupling to a second component. The second end of the first pipe section is inserted into the primary end of the second pipe section to define a pipe nipple. The first pipe section is adjustably extendable relative to the second pipe section for adjusting to a gap between the first component and the second component.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to pipe nipple devices and more particularly pertains to a new pipe nipple device for adjusting a length of a pipe nipple to facilitate bridging of a gap between two components being joined together by the pipe nipple. (2) Description of Related Art including information disclosed under 37 CFR 1.97 and 1.98.

The prior art relates to pipe nipple devices. Known pipe nipple devices lack adjustable lengths to custom fit between components being joined.

### (H) BRIEF SUMMARY OF THE INVENTION

An embodiment of the disclosure meets the needs presented above by generally comprising a first pipe section having an open first end and an open second end. First pipe threading is positioned adjacent the first end for coupling to a first component. A second pipe section has an open primary end and an open secondary end. Second pipe threading is positioned at the secondary end for coupling to a second component. The second end of the first pipe section is inserted into the primary end of the second pipe section to define a pipe nipple. The first pipe section is adjustably extendable relative to the second pipe section for adjusting to a gap between the first component and the second component.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a adjustable length pipe nipple device according to an embodiment of the disclosure.

FIG. 2 is a top front side perspective view of an embodiment of the disclosure in an extended position.

FIG. 3 is a top view of an embodiment of the disclosure.

FIG. 4 is a cross-sectional view of an embodiment of the disclosure taken along line 4 -4 of FIG. 3.

FIG. 5 is a partial cut-away side view of an embodiment of the disclosure.

### (J) DETAILED DESCRIPTION OF THE INVENTION

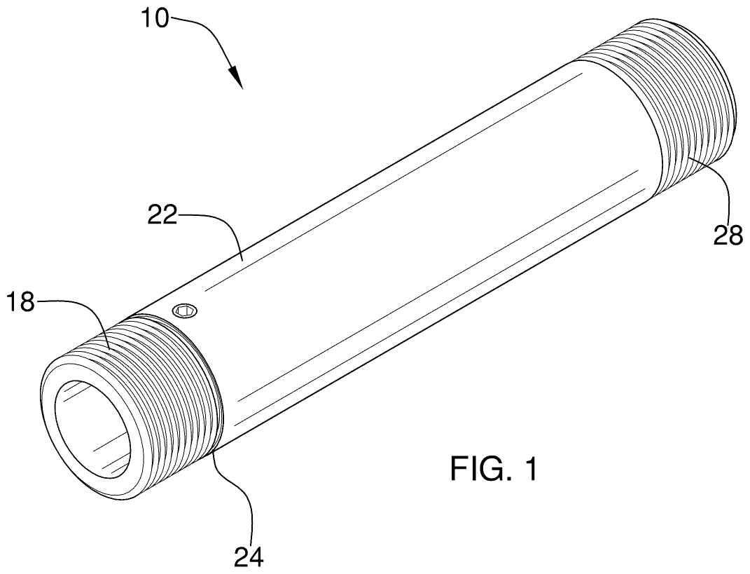

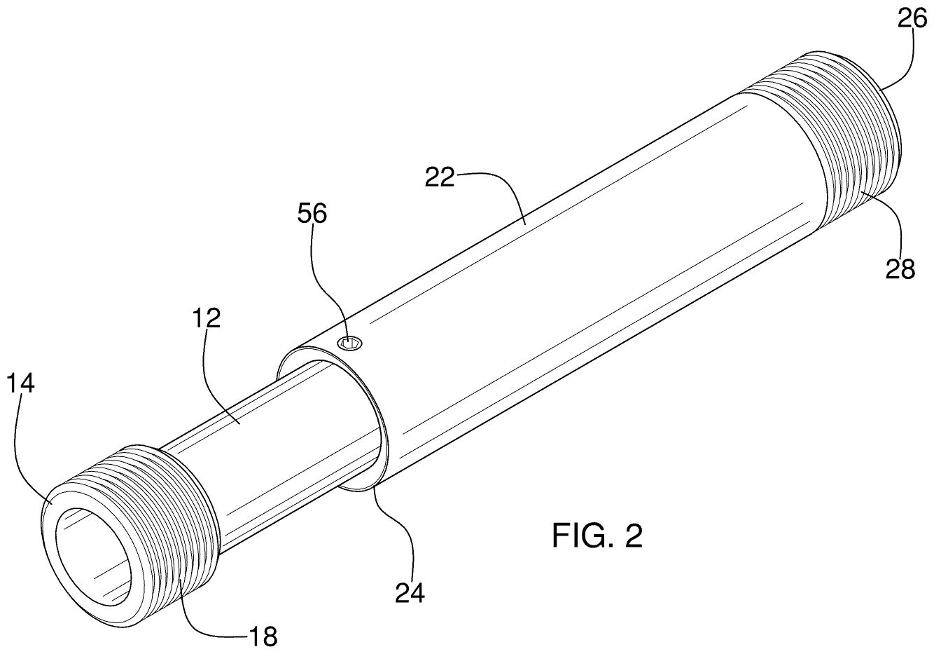

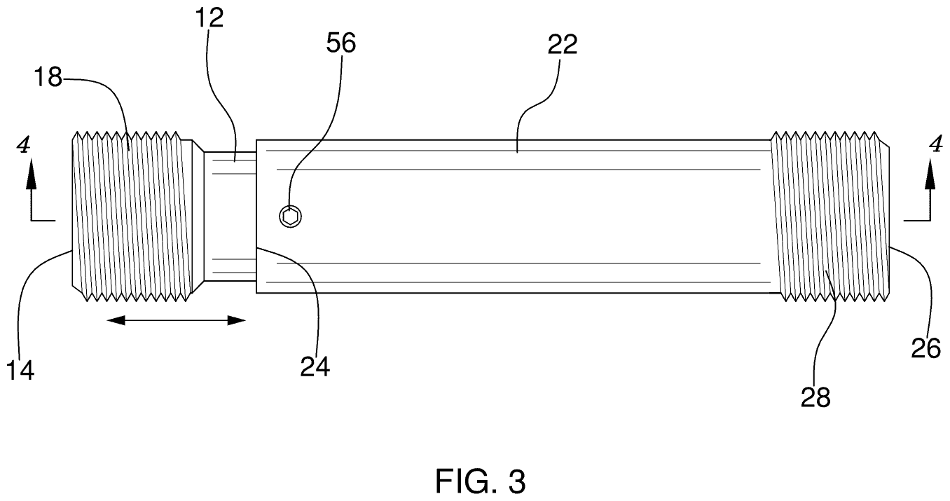

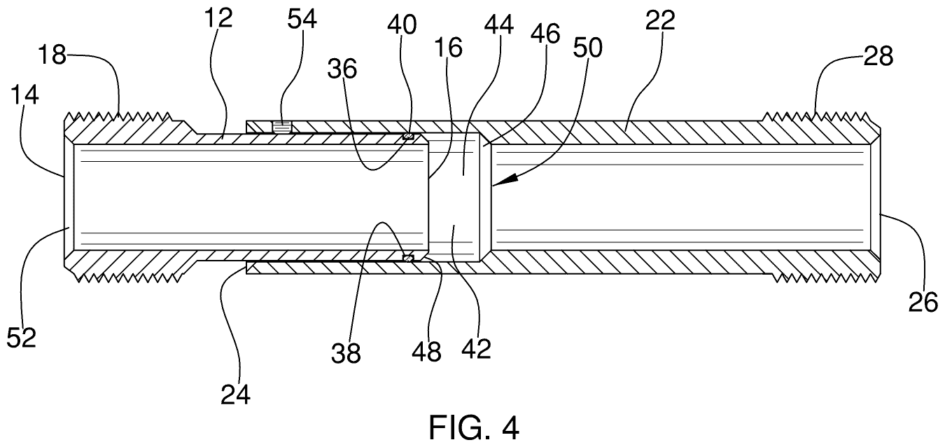

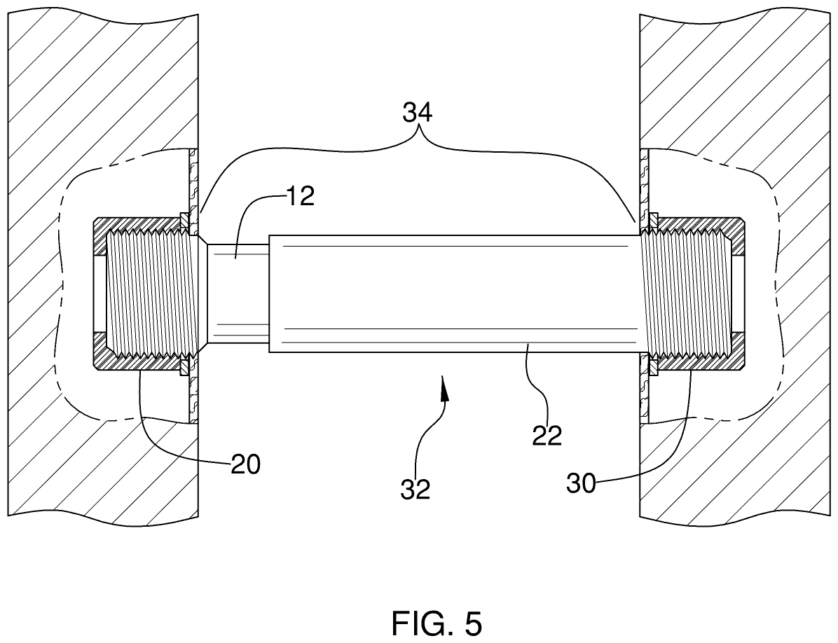

With reference now to the drawings, and in particular to FIGS. 1 through 5 thereof, a new pipe nipple device embodying the principles and concepts of an embodiment of the disclosure and generally designated by the reference numeral 10 will be described.

As best illustrated in FIGS. 1 through 5, the adjustable length pipe nipple device 10 generally comprises a first pipe section 12 having a first end 14 and a second end 16. The first end 14 and the second end 16 are open. First pipe threading 18 is positioned adjacent the first end 14 of the first pipe section 12 wherein the first pipe section 12 is configured for coupling to a first component 20. A second pipe section 22 has a primary end 24 and a secondary end 26. The primary end 24 and the secondary end 26 are open. Second pipe threading 28 is positioned at the secondary end 26 of the second pipe section 22 wherein the second pipe section 22 is configured for coupling to a second component 30. The second end 16 of the first pipe section 12 is inserted into the primary end 24 of the second pipe section 22 to define a pipe nipple 32. The first pipe section 12 is adjustably extendable relative to the second pipe section 22 wherein the pipe nipple 32 is configured for adjusting to a gap 34 between the first component 20 and the second component 30.

A seal 36 is coupled to the first pipe section 12. The seal 36 engages the second pipe section 22 wherein the seal 36 prevents leakage between the first pipe section 12 and the second pipe section 22. A seal groove 38 extends circumferentially around the first pipe section 12. The seal 36 is seated in the seal groove 38. The seal 36 has a peripheral surface 40 extending from the seal groove 38 wherein the peripheral surface 40 of the seal 36 abuts an interior surface 42 of the second pipe section 22 when the first pipe section 12 is inserted into the second pipe section 22. The seal groove 38 is positioned proximate the second end 16 of the first pipe section 12.

An interior channel 44 of the second pipe section 22 has a taper 46 positioned between the primary end 24 of the second pipe section 22 and the secondary end 26 of the second pipe section 22. An outer periphery 48 of the second end 16 of the first pipe section 12 is complementary in shape to the taper 46 in the interior channel 44 of the second pipe section 22. An internal circumference of the first pipe section 12 is equivalent to a circumference of the interior channel 44 of the second pipe section 22 at a minimum circumference 50 of the taper 46. An interior surface 52 of the first end 14 of the first pipe section 12 is flared. The interior channel 44 is flared adjacent to the secondary end 26 of the second pipe section 22.

A locking aperture 54 extends through the second pipe section 22. A set screw 56 is engageable to the locking aperture 54 such that the set screw 56 is extendable into the second pipe section 22 to frictionally engage to the first pipe section 12. Thus, the set screw 56 inhibits sliding of the first pipe section 12 relative to the second pipe section 22. In use, the first pipe section 12 is inserted into the second pipe section 22. The first pipe section 12 may be engaged to the first component 20. The length of the pipe nipple 32 is then adjustable to allow for connection of the second pipe section 22 to the second component 30. The first component 20 and second component 30 may be any piping that may require connection for whatever reason. Once connected, the set screw 56 may be tightened to inhibit sliding of the first pipe section 12 relative to the second pipe section 22. Alternatively, if so desired, the set screw 56 may be tightened to set a length of the pipe nipple 32 prior to connection of either or both of the first pipe section 12 and the second pipe section 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An adjustable length pipe nipple device comprising:
a first pipe section, said first pipe section having a first end and a second end, said first end and said second end being open;
first pipe threading positioned adjacent said first end of said first pipe section wherein said first pipe section is configured for coupling to a first component;
a second pipe section, said second pipe section having a primary end and a secondary end, said primary end and said secondary end being open;
second pipe threading positioned at said secondary end of said second pipe section wherein said second pipe section is configured for coupling to a second component; and
said second end of said first pipe section being inserted into said primary end of said second pipe section to define a pipe nipple, said first pipe section being adjustably extendable relative to said second pipe section wherein said pipe nipple is configured for adjusting to a gap between the first component and the second component; and
an interior channel of said second pipe section having a taper positioned between said primary end of said second pipe section and said secondary end of said second pipe section.

2. The adjustable length pipe nipple device of claim 1, further comprising a seal coupled to said first pipe section, said seal engaging said second pipe section wherein said seal prevents leakage between said first pipe section and said second pipe section.

3. The adjustable length pipe nipple device of claim 2, further comprising a seal groove extending circumferentially around said first pipe section, said seal being seated in said seal groove.

4. The adjustable length pipe nipple device of claim 3, further comprising said seal having a peripheral surface extending from said seal groove wherein said peripheral surface of said seal abuts an interior surface of said second pipe section when said first pipe section is inserted into said second pipe section.

5. The adjustable length pipe nipple device of claim 3, further comprising said seal groove being positioned proximate said second end of said first pipe section.

6. (canceled)

7. The adjustable length pipe nipple device of claim 1, further comprising an outer periphery of said second end of said first pipe section being complementary in shape to said taper in said interior channel of said second pipe section.

8. The adjustable length pipe nipple device of claim 7, further comprising an internal circumference of said first pipe section being equivalent to a circumference of said interior channel of said second pipe section at a minimum circumference of said taper.

9. The adjustable length pipe nipple device of claim 1, further comprising:
a locking aperture extending through said second pipe section; and
a set screw engageable to said locking aperture such that said set screw is extendable into said second pipe section to frictionally engage to said first pipe section whereby said set screw inhibits sliding of said first pipe section relative to said second pipe section.

10. The adjustable length pipe nipple device of claim 1, further comprising an interior surface of said first end of said first pipe section being flared.

11. The adjustable length pipe nipple device of claim 6, further comprising said interior channel being flared adjacent to said secondary end of said second pipe section.

12. An adjustable length pipe nipple device comprising:
a first pipe section, said first pipe section having a first end and a second end, said first end and said second end being open;
first pipe threading positioned adjacent said first end of said first pipe section wherein said first pipe section is configured for coupling to a first component;
a second pipe section, said second pipe section having a primary end and a secondary end, said primary end and said secondary end being open;
second pipe threading positioned at said secondary end of said second pipe section wherein said second pipe section is configured for coupling to a second component; and
said second end of said first pipe section being inserted into said primary end of said second pipe section to define a pipe nipple, said first pipe section being adjustably extendable relative to said second pipe section wherein said pipe nipple is configured for adjusting to a gap between the first component and the second component;
a seal being coupled to said first pipe section, said seal engaging said second pipe section wherein said seal prevents leakage between said first pipe section and said second pipe section;
a seal groove extending circumferentially around said first pipe section, said seal being seated in said seal groove, said seal having a peripheral surface extending from said seal groove wherein said peripheral surface of said seal abuts an interior surface of said second pipe section when said first pipe section is inserted into said second pipe section, said seal groove being positioned proximate said second end of said first pipe section;
an interior channel of said second pipe section having a taper positioned between said primary end of said second pipe section and said secondary end of said second pipe section;
an outer periphery of said second end of said first pipe section being complementary in shape to said taper in said interior channel of said second pipe section;
an internal circumference of said first pipe section being equivalent to a circumference of said interior channel of said second pipe section at a minimum circumference of said taper, an interior surface of said first end of said first pipe section being flared, said interior channel being flared adjacent to said secondary end of said second pipe section;
a locking aperture extending through said second pipe section; and
a set screw engageable to said locking aperture such that said set screw is extendable into said second pipe section to frictionally engage to said first pipe section whereby said set screw inhibits sliding of said first pipe section relative to said second pipe section.
